(19) United States
(12) Patent Application Publication
(10) Pub. No.: US 2026/0160325 A1
(43) Pub. Date: Jun. 11, 2026

(54) POWER TRANSMISSION STRUCTURE AND OFF-ROAD VEHICLE

(71) Applicant: KAWASAKI MOTORS, LTD., Akashi-shi (JP)

(72) Inventors: Takashi SHIOMITSU, Akashi-shi (JP); Yuki NAKAMURA, Akashi-shi (JP)

(73) Assignee: KAWASAKI MOTORS, LTD., Akashi-shi (JP)

(21) Appl. No.: 19/406,621

(22) Filed: Dec. 2, 2025

(30) Foreign Application Priority Data
Dec. 11, 2024 (JP) 2024-216537

(51) Int. Cl. F16H 57/035; B60K 17/08; B62D 63/04; F16H 9/14; F16H 57/02; F16H 57/027

(52) U.S. Cl. CPC F16H 57/035; B60K 17/08; F16H 9/14; F16H 57/027; B62D 63/04; F16H 2057/02056

(57) ABSTRACT

A continuously variable transmission includes a belt transmission mechanism having a drive pulley, a driven pulley, and a belt, and a case having an internal space in which the belt transmission mechanism is housed, an intake port through which air is sucked into the internal space, and an exhaust port through which air is discharged from the internal space. The case has a bowl-shaped cup portion housing the drive pulley. The cup portion covers at least part of a rotary portion of the drive pulley. The cup portion has a rotary portion facing surface facing the rotary portion in the radial direction thereof. The exhaust port is opened in the rotary portion facing surface.

### CROSS-REFERENCE TO RELATED APPLICATION

This application claims priority to Japanese Patent Application No. 2024-216537 filed on Dec. 11, 2024. The entire contents disclosed in this Japanese patent application, which includes the specification, the drawings, and the claims, are incorporated by reference herein.

### FIELD

The technique disclosed here relates to a power transmission structure and an off-road vehicle.

### BACKGROUND

U.S. Patent Application Publication No. 2023/0341045 discloses a vehicle having a continuously variable transmission. The continuously variable transmission has a power transmission mechanism and a case housing the power transmission mechanism. The power transmission mechanism includes a drive pulley, a driven pulley, and a belt. The case includes an intake port for sucking air and an exhaust port for discharging air.

### BRIEF DESCRIPTION OF THE DRAWINGS

FIG. 1 is a left side view of a utility vehicle.

FIG. 2 is an exploded perspective view showing a continuously variable transmission from the rear left side.

FIG. 3 is an exploded perspective view showing the continuously variable transmission from the rear right side.

FIG. 4 is a sectional view of the continuously variable transmission taken along a plane including the axis of a drive pulley and the axis of a driven pulley.

FIG. 5 is a sectional view of a portion of the continuously variable transmission including a first chamber when viewed from the left side.

FIG. 6 is a sectional view of a portion of the continuously variable transmission including a fixed sheave of the drive pulley when viewed from the left side.

FIG. 7 is a sectional view of a portion of the continuously variable transmission including the fixed sheave of the drive pulley, a movable sheave of the driven pulley, and a belt when viewed from the left side.

FIG. 8 is a sectional view of a portion of the continuously variable transmission including a movable sheave of the drive pulley and a rotary portion of the drive pulley when viewed from the left side.

### DESCRIPTION OF EMBODIMENTS

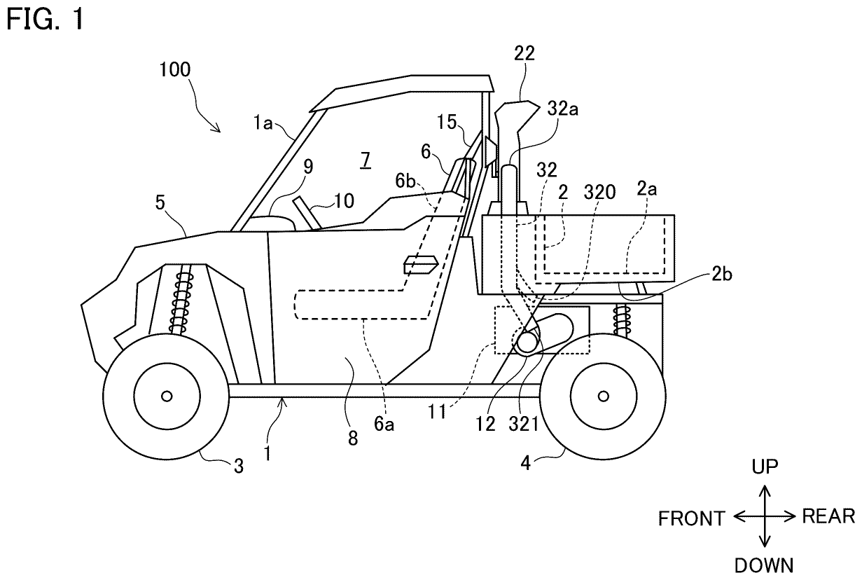

Hereinafter, an exemplary embodiment will be described in detail with reference to the drawings. FIG. 1 is a left side view of a utility vehicle 100. The utility vehicle 100 can travel off road. The utility vehicle 100 is one example of an off-road vehicle of the present disclosure. Hereinafter, the utility vehicle 100 will also be referred to as a “vehicle 100”. The utility vehicle has, for example, a loading platform, a roll over protective structure (ROPS), or a low-pressure tire. The utility vehicle is, for example, a side by side vehicle. The utility vehicle travels on an unpaved uneven ground in some cases. For example, the utility vehicle may travel in a marshy area, or cross a river. The utility vehicle may travel in an area where a water surface is positioned in the vicinity of a seating surface of a seat.

In the present disclosure, each component of the vehicle 100 will be described using a direction with respect to the vehicle 100. Specifically, a “front” means the front of the vehicle 100 in a vehicle front-rear direction, and a “rear” means the rear of the vehicle 100 in the vehicle front-rear direction. A “left” means the left when facing the front of the vehicle 100, and a “right” means the right when facing the front of the vehicle 100. A “vehicle width direction” means the width direction of the vehicle 100, and in other words, means the right-left direction of the vehicle 100 and will also be referred to as a “right-left direction”. An “inside in the vehicle width direction” means a vehicle interior side in the vehicle width direction, and an “outside in the vehicle width direction” means a vehicle outer side in the vehicle width direction. The vehicle 100 includes a vehicle body frame 1, right and left front wheels 3 supporting a front portion of the vehicle body frame 1, and right and left rear wheels 4 supporting a rear portion of the vehicle body frame 1. That is, the vehicle 100 is a four-wheeled vehicle. In this example, the rear wheels 4 are drive wheels. A space between the right and left front wheels 3 is covered with a hood 5 from above. Right and left seats 6 supported by the vehicle body frame 1 are located on the rear side of the hood 5. The seats 6 are in one line, but may be in two lines.

The seat 6 has a seating portion 6a and a back portion 6b. The seating portion 6a supports the hip of an occupant. The back portion 6b supports the back of the occupant. A seat belt 15 is attached to the vehicle body frame 1. The seat belt 15 holds the occupant on the seat 6. The seat belt 15 is, for example, a three-point seat belt.

The vehicle body frame 1 includes hollow pipes, and the pipes are connected into the frame. The vehicle body frame 1 has a cabin frame 1a defining a vehicle cabin 7 in which the seats 6 are located. Entrances are opened on both right and left sides of the vehicle cabin 7, and are opened and closed with doors 8. A dashboard 9 is located in front of the seats 6 in the vehicle cabin 7. A steering wheel 10 is attached to the dashboard 9. A loading platform 2 is located in rear of the cabin frame 1a. The loading platform 2 is located above the rear wheels 4. The loading platform 2 includes a recessed loading space 2a opened upward.

The vehicle 100 has an engine 11 and a continuously variable transmission 12. The engine 11 is one example of a drive source of the present disclosure. The continuously variable transmission 12 is one example of a power transmission structure of the present disclosure. The engine 11 and the continuously variable transmission 12 are located below the loading platform 2 in rear of the seats 6. The engine 11 and the continuously variable transmission 12 face the bottom surface 2b of the loading platform 2. Note that the vehicle 100 may have a generator that generates power by the power of the engine 11, a battery that stores the power generated by the generator, and the like.

The engine 11 generates the power. The engine 11 is, for example, a reciprocating engine. The engine 11 has a casing, a piston, and a crankshaft. The piston and the crankshaft are located in the casing. The crankshaft is coupled to the piston, and converts reciprocating motion of the piston into rotational motion.

The continuously variable transmission 12 transmits the power output from the engine 11 to the rear wheels 4. The continuously variable transmission 12 changes the rotational power from the engine 11, and outputs the changed power. Specifically, the continuously variable transmission 12 steplessly changes the rotational speed of the rotational power from the engine 11, and transmits the changed power to the rear wheels 4. A CVT intake duct 22 for guiding sucked air into the case and a CVT exhaust duct 32 for guiding exhaust air to the outside of the case are connected to the continuously variable transmission 12.

The CVT intake duct 22 and the CVT exhaust duct 32 are located in a space in front of the loading platform 2. Specifically, each duct 22, 32 is located in an area in rear of the seats 6 and in front of the loading platform 2. In other words, each duct 22, 32 is located in an area between a pillar frame positioned in rear of the seats 6 and extending in the up-down direction and a front wall of the loading platform 2.

The CVT intake duct 22 and the CVT exhaust duct 32 are located such that at least part thereof is aligned in the vehicle width direction. Specifically, an upper portion of the CVT exhaust duct 32 is located outside an upper portion of the CVT intake duct 22 in the vehicle width direction.

The CVT intake duct 22 is connected to the continuously variable transmission 12, and sends air from the outside of the vehicle into the continuously variable transmission 12. The CVT exhaust duct 32 is connected to the continuously variable transmission 12, and discharges air from the continuously variable transmission 12. Specifically, the continuously variable transmission 12 includes a suction blade at part of a rotary body to be rotated by driving. When the continuously variable transmission 12 is driven, outside air is sucked into the case of the continuously variable transmission 12 through the CVT intake duct 22 by rotation of the blade. Then, the air sucked into the continuously variable transmission 12 cools the inside of the continuously variable transmission 12, specifically the belt of the continuously variable transmission 12. Thereafter, the air inside the continuously variable transmission 12 is discharged to the outside through the CVT exhaust duct 32.

The CVT intake duct 22 is located in the space in front of the loading platform 2, and extends in the up-down direction. The inlet of the CVT intake duct 22 is located at a position higher than the continuously variable transmission 12. Specifically, the inlet of the CVT intake duct 22 is above the CVT exhaust duct 32. The inlet of the CVT intake duct 22 is located at a position higher than the seating portion 6a of the seat 6. In the present embodiment, the inlet of the CVT intake duct 22 is located at a position higher than the upper end of any one of the loading platform 2, the seat belt 15, the back portion 6b of the seat 6, or a headrest of the seat 6. The inlet of the CVT intake duct 22 is opened rearward. The outlet of the CVT intake duct 22 is connected to an intake port of the case of the continuously variable transmission 12.

The CVT exhaust duct 32 is located in the space in front of the loading platform 2, and extends in a substantially U-shape in the up-down direction. The upper end 32a of the CVT exhaust duct 32 is located at a position higher than the continuously variable transmission 12. Specifically, the inlet 321 of the CVT exhaust duct 32 is connected to an exhaust port of the case of the continuously variable transmission 12. The CVT exhaust duct 32 extends upward while extending from the inlet 321 to the downstream side in an air flow direction, is folded back at the upper end 32a, and extends downward. The outlet 320 of the CVT exhaust duct 32 is in a lower portion of the CVT exhaust duct 32. The inlet 321 of the CVT exhaust duct 32 is positioned outside the outlet 320 of the CVT exhaust duct 32 in the vehicle width direction. The upper end 32a of the CVT exhaust duct 32 is located at a position higher than the seating portion 6a of the seat 6. In the present embodiment, the upper end 32a of the CVT exhaust duct 32 is located at a position higher than the upper end of any one of the loading platform 2, the seat belt 15, the back portion 6b of the seat 6, or the headrest of the seat 6. The upper end 32a of the CVT exhaust duct 32 is positioned in front of the bottom surface 2b of the loading platform 2.

As described above, while extending from the upstream side to the downstream side in the air flow direction, the CVT exhaust duct 32 extends upward of the bottom surface 2b of the loading platform 2, is folded back, and extends downward. In this manner, the CVT exhaust duct 32 extends while being folded back and curved in the U-shape. The CVT exhaust duct 32 is folded back such that the upstream side and downstream side thereof are aligned in the vehicle width direction. Specifically, the CVT exhaust duct 32 has, on the path thereof, a curved portion extending upward and then extending downward while extending from the upstream side to the downstream side. The upper end 32a of the CVT exhaust duct 32 is located at the curved portion. A portion of the CVT exhaust duct 32 on the upstream side in the air flow direction with respect to the outlet 320 of the CVT exhaust duct 32, specifically the upper end 32a, is positioned higher than the outlet 320.

The outlet 320 of the CVT exhaust duct 32 is positioned below the bottom surface 2b of the loading platform 2. In the present embodiment, the outlet 320 is located at a position higher than the continuously variable transmission 12. The outlet 320 is positioned higher than part of the engine 11. The outlet 320 is opened to the engine 11, for example an exhaust pipe of the engine 11. The engine 11 is one example of a cooling target of the present disclosure. In this manner, the air discharged from the outlet 320 is blown to the exhaust pipe of the engine 11 to cool the exhaust pipe of the engine 11.

In the present embodiment, the CVT intake duct 22 and the CVT exhaust duct 32 are connected into a unit. Specifically, the CVT intake duct 22 and the CVT exhaust duct 32 are fixed to each other with co-fastening portions.

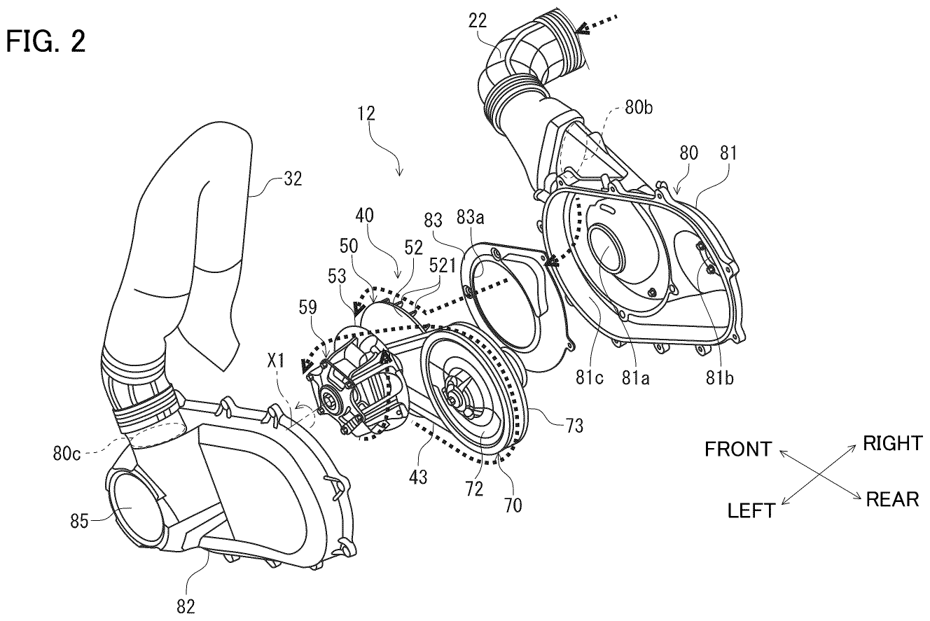

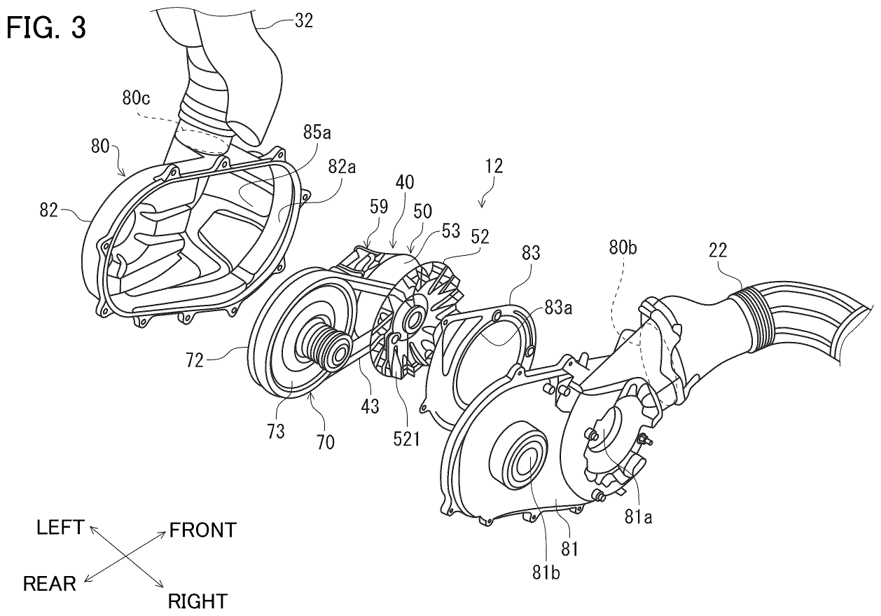

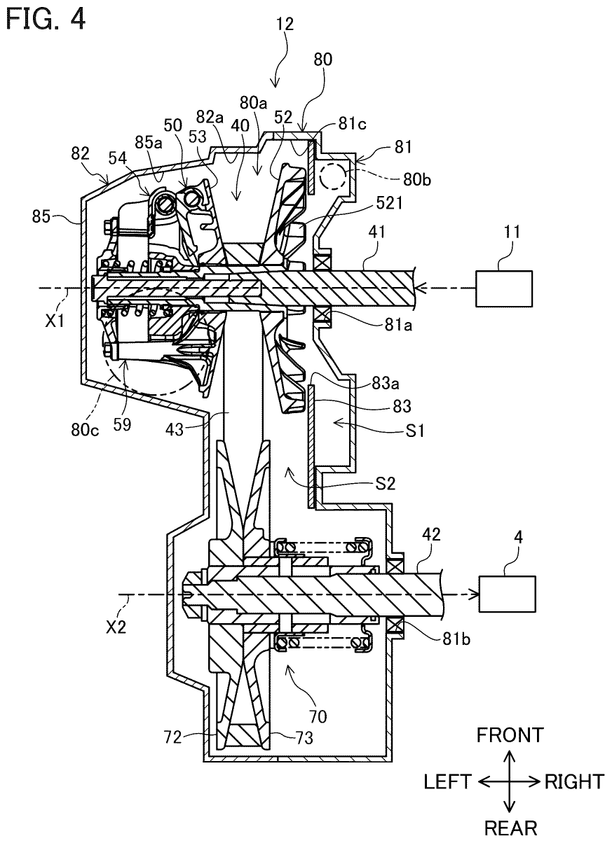

FIG. 2 is an exploded perspective view of the continuously variable transmission 12 from the rear left side. FIG. 3 is an exploded perspective view of the continuously variable transmission 12 from the rear right side. FIG. 4 is a sectional view of the continuously variable transmission 12 taken along a plane including the axis X1 of a drive pulley 50 and the axis X2 of a driven pulley 70. The continuously variable transmission 12 has a belt transmission mechanism 40 and a case 80 housing the belt transmission mechanism 40.

First, the belt transmission mechanism 40 will be described. The belt transmission mechanism 40 includes the drive pulley 50, the driven pulley 70, and a belt 43.

The drive pulley 50 receives the rotational power from the engine 11. Specifically, the drive pulley 50 is coupled to the engine 11 through an input shaft 41. The input shaft 41 is, for example, a crankshaft. The axis X1 of the drive pulley 50 is coincident with the axis of the input shaft 41.

The driven pulley 70 outputs torque to the rear wheels 4. Specifically, the driven pulley 70 is coupled to the rear wheels 4 through an output shaft 42. The output shaft 42 is, for example, a drive shaft. The axis X2 of the driven pulley 70 is coincident with the axis of the output shaft 42. Note that the output shaft 42 may be an input shaft of an auxiliary transmission (gear transmission) coupled to the rear wheels 4. The belt 43 is wound between the drive pulley 50 and the driven pulley 70. The belt 43 is a so-called V-belt. Specifically, the inner peripheral side width of the belt 43 is smaller than the outer peripheral side width of the belt 43.

The torque (rotational power) of the engine 11 is transmitted to the drive pulley 50 through the input shaft 41, rotation of the drive pulley 50 is transmitted to the driven pulley 70 through the belt 43, and rotation of the driven pulley 70 is transmitted to the rear wheels 4 through the output shaft 42. In this manner, the belt transmission mechanism 40 transmits the torque of the engine 11 to the rear wheels 4.

The drive pulley 50 is configured such that a position in the radial direction, at which the belt 43 is wound, is changeable. The driven pulley 70 is configured such that a position in the radial direction, at which the belt 43 is wound, is changeable. When the position at which the belt 43 is wound around each pulley 50, 70 is changed, the amount of angular displacement of the driven pulley 70 per rotation of the drive pulley 50 changes. In this manner, the belt transmission mechanism 40 changes the rotational speed of the engine 11 to transmit the changed power to the rear wheels 4.

The drive pulley 50 has a fixed sheave 52 and a movable sheave 53. The fixed sheave 52 and the movable sheave 53 face each other.

Air suction blades 521 are disposed on the back surface of the fixed sheave 52 opposite to the movable sheave 53. The case 80 of the continuously variable transmission 12 includes, at a position facing the blades 521, an intake port 80b communicating with the CVT intake duct 22. By rotating the fixed sheave 52, air around the fixed sheave 52 flows outward in the radial direction due to centrifugal force, and in this manner, outside air is sucked into the case 80.

The movable sheave 53 changes its position in a direction along the axis X1 according to rotation of the input shaft 41. The movable sheave 53 approaches the fixed sheave 52 as the number of rotations of the input shaft 41 increases. That is, as the number of rotations of the input shaft 41 increases, the belt 43 moves outward in the radial direction of the drive pulley 50.

The drive pulley 50 has a rotational motion mechanism 54 that moves the movable sheave 53 in the direction along the axis X1. The rotational motion mechanism 54 is positioned on the opposite side of the movable sheave 53 from the fixed sheave 52. In other words, the movable sheave 53 is positioned between the rotational motion mechanism 54 and the fixed sheave 52. An existing structure can be applied as the rotational motion mechanism 54. For example, as the rotational motion mechanism 54, a spring mechanism that moves the movable sheave 53 in the direction along the axis X1 by the centrifugal force generated by rotation of the input shaft 41 may be used. For example, such a spring mechanism is implemented using a structure positioned on the opposite side of the movable sheave 53 from the fixed sheave 52, such as a centrifugal weight, a spring, a spider, a shaft sleeve, a guide rod, or a cover.

The driven pulley 70 has a fixed sheave 72 and a movable sheave 73. The fixed sheave 72 and the movable sheave 73 face each other.

The movable sheave 73 changes its position in a direction along the axis X2 according to rotation of the input shaft 41. The movable sheave 73 moves apart from the fixed sheave 72 as the number of rotations of the input shaft 41 increases. Specifically, as the number of rotations of the input shaft 41 increases, the tension of the belt 43 increases, and the inward force of the belt 43 in the radial direction of the driven pulley 70 increases. Accordingly, the movable sheave 73 moves apart from the fixed sheave 72 against spring force, and the belt 43 moves inward in the radial direction of the driven pulley 70.

The case 80 has an internal space 80a, the intake port 80b, and an exhaust port 80c. The internal space 80a houses the belt transmission mechanism 40. The intake port 80b allows the CVT intake duct 22 and the internal space 80a to communicate with each other. The exhaust port 80c communicates with the CVT exhaust duct 32 and the internal space 80a.

Specifically, the case 80 has a case body 81 and a cover 82. The case 80 is positioned below the loading platform 2. The case body 81 and the cover 82 are combined in the direction along the axis X1 to define the internal space 80a in which the belt transmission mechanism 40 is housed. The case body 81 is located on one side (first side) of the drive pulley 50 in the direction along the axis X1. The cover 82 is located on the other side (second side) of the drive pulley 50 in the direction along the axis X1. Specifically, the case body 81 is located on the engine 11 side (right side in the present embodiment). The cover 82 is located on the side opposite to the engine 11 (left side in the present embodiment).

The case body 81 is opened on the other side of the drive pulley 50 in the direction along the axis X1. The cover 82 is opened on the one side of the drive pulley 50 in the direction along the axis X1. The opening of the cover 82 faces the opening of the case body 81. The cover 82 is attached to the case body 81 with a fastener to close the case body 81.

The case body 81 includes the intake port 80b. FIG. 4 schematically shows the intake port 80b. The intake port 80b is positioned on the opposite side of the fixed sheave 52 from the movable sheave 53. In other words, the fixed sheave 52 is positioned between the intake port 80b and the movable sheave 53. In the present embodiment, the intake port 80b is located so as to extend in the up-down direction.

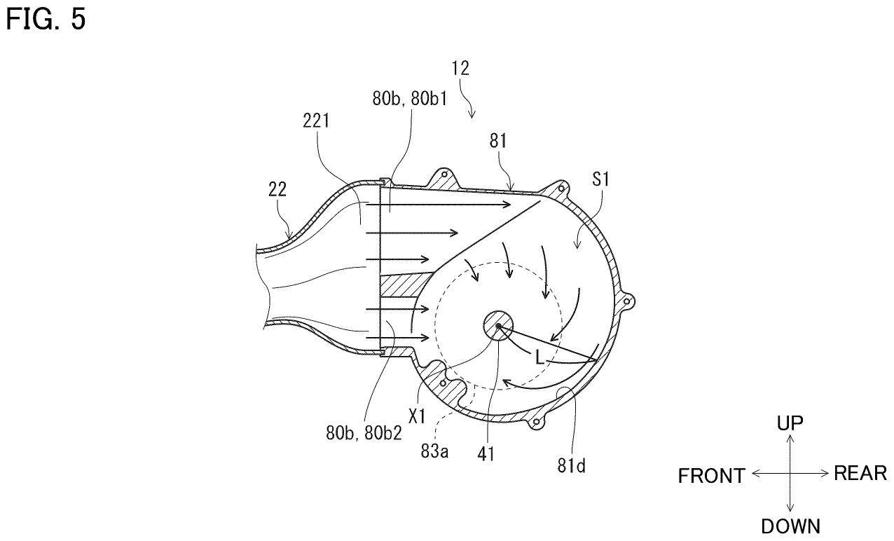

The outlet 221 (see FIG. 5) of the CVT intake duct 22 is connected to the intake port 80b of the case body 81. Thus, air is sucked through the CVT intake duct 22, and is guided into the case body 81.

The case body 81 includes a first through-hole 81a and a second through-hole 81b. The input shaft 41 is inserted into the first through-hole 81a, and is supported on the inner surface of the first through-hole 81a through a bearing. The output shaft 42 is inserted into the second through-hole 81b, and is supported on the inner surface of the second through-hole 81b through a bearing.

The case body 81 houses the fixed sheave 52. The case body 81 includes a fixed sheave facing surface 81c. The fixed sheave facing surface 81c faces the fixed sheave 52 in the radial direction of the fixed sheave 52.

The cover 82 includes the exhaust port 80c. FIG. 4 schematically shows the exhaust port 80c. The exhaust port 80c is positioned in a front portion of the case 80. The exhaust port 80c is positioned on the opposite side of the movable sheave 53 from the fixed sheave 52. In other words, the movable sheave 53 is positioned between the exhaust port 80c and the fixed sheave 52. The exhaust port 80c overlaps with a rotary portion 59 when viewed in a direction along the center of the exhaust port 80c. That is, the exhaust port 80c overlaps with the rotary portion 59 when viewed from a direction perpendicular to the plane including the axis X1 of the drive pulley 50 and the axis X2 of the driven pulley 70.

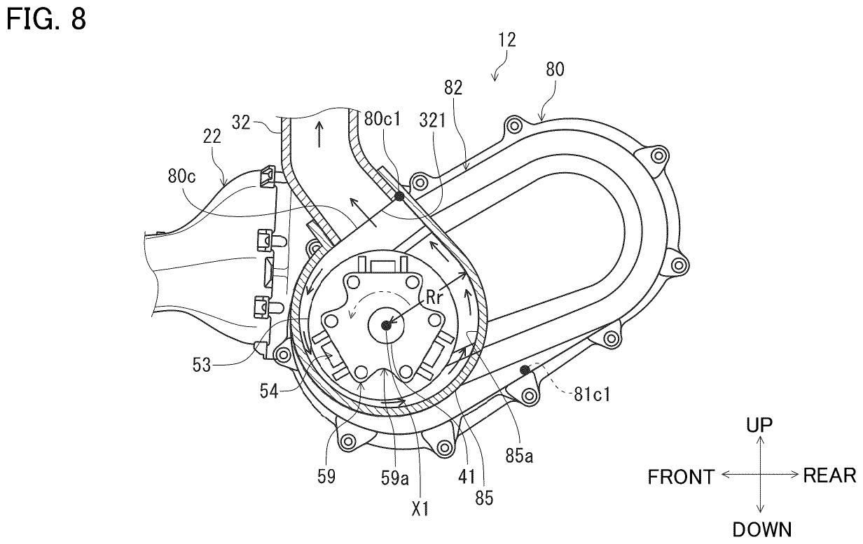

The inlet 321 (see FIG. 8) of the CVT exhaust duct 32 is connected to the exhaust port 80c of the cover 82. Thus, air is discharged to the CVT exhaust duct 32 from the inside of the cover 82.

The cover 82 houses the movable sheave 53 and the rotary portion 59. The cover 82 has a cup portion 85. The cup portion 85 protrudes to the other side of the drive pulley 50 in the direction along the axis X1. Specifically, the cup portion 85 protrudes to the side opposite to the engine 11 (left side in the present embodiment). The cup portion 85 houses the movable sheave 53 and the rotary portion 59.

As described above, the case 80 includes the bowl-shaped cup portion 85 housing the drive pulley 50. The cup portion 85 protrudes in the direction along the axis X1 with respect to the remaining portion of the cover 82. The drive pulley 50 is one example of one pulley of the present disclosure. The cup portion 85 covers at least part of the rotary portion 59 of the drive pulley 50 rotating about the axis X1 thereof. In other words, the cup portion 85 covers a portion of the drive pulley 50 rotating together with the movable sheave 53. The rotary portion 59 rotating together with the movable sheave 53 includes the rotational motion mechanism 54 such as a spider, a guide rod, or a cover. The rotary portion 59 is positioned on the opposite side of the movable sheave 53 from the fixed sheave 52. In other words, the movable sheave 53 is positioned between the rotary portion 59 and the fixed sheave 52. The cup portion 85 includes a tubular portion coaxial with the axis X1, and a lid portion covering the tubular portion in the direction along the axis X1. The cup portion 85 has a rotary portion facing surface 85a facing the rotary portion 59 in the radial direction of the rotary portion 59. In other words, the above-described tubular portion of the cup portion 85 covers the rotary portion 59 rotating together with the movable sheave 53 from the outside in the radial direction. In the present embodiment, the cup portion 85 decreases in a dimension in the radial direction with an increase in a distance from the fixed sheave 52 in the direction along the axis X1. As shown in FIG. 4, the cup portion 85 covers the back surface of the movable sheave 53 in a state of rotation of the input shaft 41 being stopped. The movable sheave 53 moves toward the fixed sheave 52 in the direction along the axis X1 as the input shaft 41 rotates, and therefore, an interval between the inner surface of the cup portion 85 and the rotary portion 59 in the radial direction increases as the number of rotations of the input shaft 41 increases.

The above-described exhaust port 80c is opened in the rotary portion facing surface 85a of the cup portion 85. Specifically, the dimension of the exhaust port 80c in the direction along the axis X1 is substantially equal to the dimension of the cup portion 85 in the direction along the axis X1. The exhaust port 80c is positioned higher than the axis X1 in the cup portion 85. Moreover, the exhaust port 80c is positioned closer to the axis X2 of the driven pulley 70 with respect to the axis X1 of the drive pulley 50 in the cup portion 85.

As shown in FIG. 4, the cover 82 houses the fixed sheave 72 and movable sheave 73 of the driven pulley 70. The cover 82 houses the belt 43. The cover 82 includes a belt facing surface 82a. The belt facing surface 82a faces the belt 43 in the radial direction thereof.

A partition plate 83 is attached inside the case 80. Specifically, the partition plate 83 is attached inside the case body 81. The partition plate 83 extends in the radial direction of the drive pulley 50. The partition plate 83 faces the one side (right side in the present embodiment) of the fixed sheave 52 in the direction along the axis X1.

The partition plate 83 partitions the internal space 80a into a first chamber S1 and a second chamber S2. The first chamber S1 communicates with the intake port 80b. The second chamber S2 communicates with the exhaust port 80c. The belt transmission mechanism 40 is located in the second chamber S2.

The partition plate 83 includes a communication hole 83a. The communication hole 83a faces an inner-diameter-side portion of the fixed sheave 52. The communication hole 83a allows the first chamber S1 to communicate with the second chamber S2. The input shaft 41 is inserted into the communication hole 83a.

FIG. 5 is a sectional view of a portion of the continuously variable transmission 12 including the first chamber S1 when viewed from the left side. In FIG. 5, the flow of air is indicated by solid arrows. In FIG. 5, the first through-hole 81a of the case body 81 is not shown. The first through-hole 81a is closed with the input shaft 41 and the bearing supporting the input shaft 41, and the first chamber S1 does not communicate with the outside through the first through-hole 81a.

The outlet 221 of the CVT intake duct 22 communicates with the intake port 80b of the case body 81. Air flows from the outlet 221 to the intake port 80b. The intake port 80b includes a first intake port 80b1 and a second intake port 80b2. The first intake port 80b1 is located above the second intake port 80b2.

The case body 81 includes an inner peripheral surface 81d defining the first chamber S1. The inner peripheral surface 81d is a surface facing the first chamber S1 from the outside in the radial direction perpendicular to the axis X1. The inner peripheral surface 81d is a surface extending in the circumferential direction about the axis X1. The inner peripheral surface 81d faces the first intake port 80b1 and the second intake port 80b2. The inner peripheral surface 81d has such a shape that a distance L from the axis X1 decreases with an increase in a distance from the first intake port 80b1 in the circumferential direction. The shape of the inner peripheral surface 81d is a so-called scroll shape. The shape of the inner peripheral surface 81d is, for example, a non-circular shape when viewed in the direction along the axis X1.

When viewed in the direction along the axis X1, the first intake port 80b1 faces the inner peripheral surface 81d, and the second intake port 80b2 faces the communication hole 83a of the partition plate 83. Air having flowed in through the first intake port 80b1 passes through the outer diameter side of the communication hole 83a, and is sucked into the second chamber S2 (see FIG. 4) through the communication hole 83a while being guided by the inner peripheral surface 81d. The air having flowed in through the second intake port 80b2 flows directly toward the communication hole 83a, and is sucked into the second chamber S2 through the communication hole 83a.

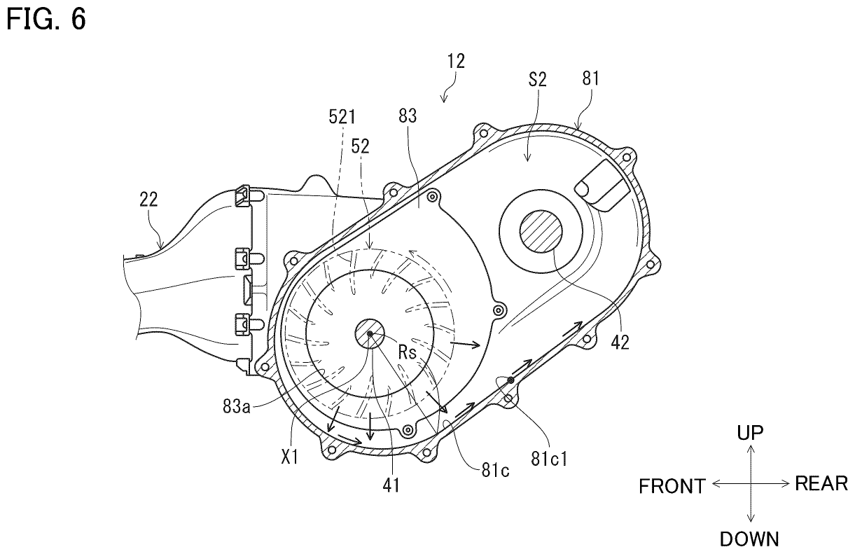

FIG. 6 is a sectional view of a portion of the continuously variable transmission 12 including the fixed sheave 52 when viewed from the left side. In FIG. 6, the flow of air is indicated by solid arrows. In FIG. 6, the first through-hole 81a and second through-hole 81b of the case body 81 are not shown. The second through-hole 81b is closed with the output shaft 42 and the bearing supporting the output shaft 42, and the second chamber S2 does not communicate with the outside through the second through-hole 81b. In FIG. 6, the fixed sheave 52 is indicated by a dash-dot-dot line, and the rotation direction of the fixed sheave 52 (i.e., the rotation direction of the drive pulley 50) is indicated by a dash-dot-dot arrow.

The fixed sheave facing surface 81c is a surface extending in the circumferential direction about the axis X1. The fixed sheave facing surface 81c is a surface of the inner surface of the case body 81, whose distance from the outer peripheral surface of the fixed sheave 52 in the radial direction thereof is a predetermined value or less. The inner diameter dimension Rs of the fixed sheave facing surface 81c from the axis X1 increases with an increase in a distance from the intake port 80b in the rotation direction of the drive pulley 50 (fixed sheave 52). That is, the inner diameter dimension Rs of the fixed sheave facing surface 81c increases toward the downstream side in the air flow direction.

By rotating the blades 521 along with rotation of the fixed sheave 52, air in the vicinity of the communication hole 83a is sent outward in the radial direction in the second chamber S2. The air flows along the fixed sheave facing surface 81c.

When the blades 521 send the air in the vicinity of the communication hole 83a outward in the radial direction, a negative pressure is generated in the vicinity of the communication hole 83a in the second chamber S2, and the air in the first chamber S1 (see FIG. 5) is sucked into the second chamber S2 through the communication hole 83a. The rotation direction (counterclockwise direction in FIG. 6) of the fixed sheave 52 is a direction opposite to a whirling direction (clockwise direction in FIG. 5) of air flowing to the downstream side around the communication hole 83a in the first chamber S1.

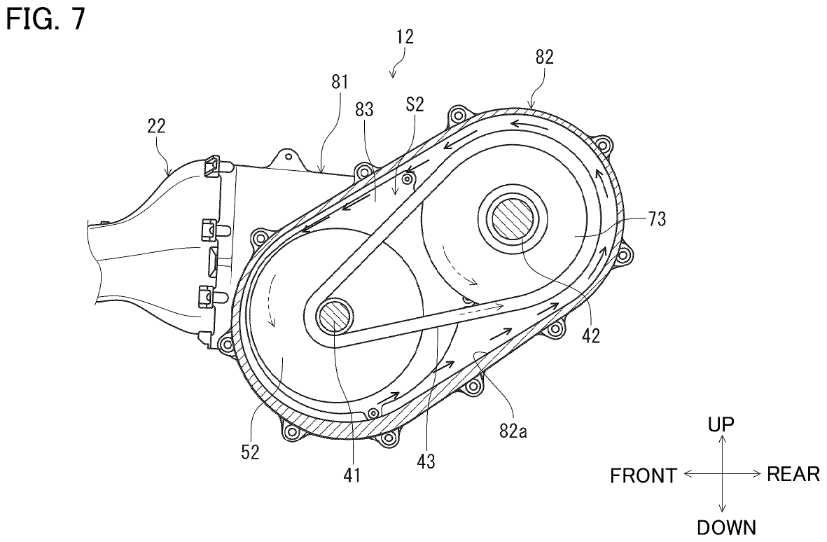

FIG. 7 is a sectional view of a portion of the continuously variable transmission 12 including the fixed sheave 52, the movable sheave 73, and the belt 43 when viewed from the left side. In FIG. 7, the flow of air is indicated by solid arrows. In FIG. 7, the rotation direction of the fixed sheave 52 (i.e., the rotation direction of the drive pulley 50), the rotation direction of the movable sheave 73 (i.e., the rotation direction of the driven pulley 70), and the rotation direction of the belt 43 are indicated by dash-dot-dot arrows. The rotation direction of the fixed sheave 52, the rotation direction of the movable sheave 73, and the rotation direction of the belt 43 are the same as each other, and in this example, are the counterclockwise direction.

The belt facing surface 82a is a surface extending in the circumferential direction about the belt 43. The belt facing surface 82a is a surface facing the entire outer peripheral surface of the belt 43 in the circumferential direction.

The air having flowed along the fixed sheave facing surface 81c in FIG. 6 flows toward the driven pulley 70 side along the inner surface of the cover 82. Specifically, the air near the belt 43 flows, when the belt 43 moves toward the driven pulley 70, along the belt facing surface 82a along with such movement of the belt 43. At this time, the air cools the belt 43 while flowing along the belt facing surface 82a.

In FIG. 7, the air having reached the driven pulley 70 side deflects its direction along the inner surface of the cover 82, and flows toward the drive pulley 50 side. Specifically, by rotating the driven pulley 70, force of moving the air toward the drive pulley 50 side is applied to the air having reached the driven pulley 70 side. The air flowing apart from the driven pulley 70 and flowing near the belt 43 flows, when the belt 43 moves toward the drive pulley 50, toward the drive pulley 50 along with such movement of the belt 43.

FIG. 8 is a sectional view of a portion of the continuously variable transmission 12 including the movable sheave 53 and the rotary portion 59 when viewed from the left side. In FIG. 8, the flow of air is indicated by solid arrows. In FIG. 8, the rotation direction of the movable sheave 53 and the rotary portion 59 (i.e., the rotation direction of the drive pulley 50) is indicated by a dash-dot-dot arrow. The rotation direction of the movable sheave 53 and the rotary portion 59 is the counterclockwise direction in this example.

Force of rotating the air together along with rotation of the rotary portion 59 is applied to the air having approached the drive pulley 50 through the vicinity of the driven pulley 70, and the air rotates along the rotary portion facing surface 85a of the cup portion 85.

The rotary portion facing surface 85a is a surface extending in the circumferential direction about the axis X1. The rotary portion facing surface 85a is a surface of the inner surface of the cup portion 85, whose distance from the outer peripheral surface of the rotary portion 59 in the radial direction thereof is a predetermined value or less. The inner diameter dimension Rr of the rotary portion facing surface 85a from the axis X1 increases toward the exhaust port 80c in the rotation direction of the drive pulley 50 (rotary portion 59). That is, the inner diameter dimension Rr of the rotary portion facing surface 85a increases toward the downstream side in the air flow direction. The shape of the rotary portion facing surface 85a is a so-called scroll shape. The shape of the rotary portion facing surface 85a is, for example, a non-circular shape when viewed in the direction along the axis X1.

The rotary portion 59 has a recessed-projecting portion 59a whose dimension in the radial direction varies in the rotation direction of the drive pulley 50. Specifically, the recessed-projecting portion 59a is defined by the recessed-projecting shape of the member of the rotational motion mechanism 54 when viewed in the direction along the axis X1. For example, the recessed-projecting portion 59a is defined by a projecting shape of a spider or a guide rod, a recessed shape of a cover, or the like.

The exhaust port 80c is opened upward. The exhaust port 80c is opened in an upper portion of the rotary portion facing surface 85a. The rear end 80c1 of the exhaust port 80c is positioned in rear of the axis X1.

When viewed in the direction along the axis X1, the exhaust port 80c is positioned on the opposite side of the axis X1 from a far position 81c1 of the fixed sheave facing surface 81c. In other words, the axis X1 is positioned between the exhaust port 80c and the far position 81c1 of the fixed sheave facing surface 81c. In FIG. 8, the far position 81c1 of the fixed sheave facing surface 81c is indicated by a dot. As shown in FIG. 6, the far position 81c1 of the fixed sheave facing surface 81c is a position on the downstream side in the air flow direction, at which the inner diameter dimension Rs of the fixed sheave facing surface 81c from the axis X1 is maximum.

The air positioned in the vicinity of the rotary portion 59 in the cup portion 85 is rotated about the axis X1 and centrifugal force is applied thereto by rotation of the rotary portion 59, and such air flows toward the exhaust port 80c along the rotary portion facing surface 85a. At this time, when the rotary portion 59 sends the air in the cup portion 85 to the exhaust port 80c, a negative pressure is generated inside the cup portion 85, and the air flowing along the belt facing surface 82a is sucked into the cup portion 85. In this manner, the air flowing along the belt facing surface 82a in FIG. 7 flows along the rotary portion facing surface 85a and is discharged from the exhaust port 80c by rotation of the rotary portion 59.

A series of air flow in the continuously variable transmission 12 in the present embodiment is as follows. As indicated by dashed arrows in FIG. 2, air having flowed into the case 80 through the CVT intake duct 22 first passes through the communication hole 83a of the partition plate 83, and flows around the fixed sheave 52 of the drive pulley 50. Thereafter, the air flows around the belt 43, flows around the rotary portion 59 of the drive pulley 50, and is then discharged to the CVT exhaust duct 32.

According to the continuously variable transmission 12 and the vehicle 100 as described above, the cup portion 85 of the case 80 covers at least part of the rotary portion 59 of the drive pulley 50, the cup portion 85 has the rotary portion facing surface 85a, and the exhaust port 80c is opened in the rotary portion facing surface 85a. With this configuration, in a case where the drive pulley 50 rotates about the axis X1, the air positioned in the vicinity of the rotary portion 59 in the cup portion 85 rotates about the axis X1 and the centrifugal force is applied thereto by rotation of the rotary portion 59. In this manner, the air positioned in the cup portion 85 is prompted to move toward the exhaust port 80c along the rotary portion facing surface 85a, and air discharging performance can be enhanced. Consequently, the inside of the case 80 can be ventilated, and an increase in the temperature of the belt 43 can be suppressed.

Specifically, as the belt 43, a belt made of a non-metal material such as resin is used. The temperature of the belt 43 may increase due to frictional heat at the time of power transmission. The temperature of the belt 43 tends to increase upon power transmission under high load and high rotation. In the case of the resin belt, when power transmission is continued under high temperature, the useful life of the belt may be shortened, or the strength of the belt may be decreased. In the present embodiment, external air is guided into the case 80, and air warmed in the case 80 is discharged. This prevents an increase in the temperature of the belt 43.

The belt 43 is for the CVT, and therefore, is switchable to a transmission gear ratio at which a load to be transmitted is high. The utility vehicle traveling on the uneven ground is in a power transmission state under higher load as the amount of loading on the loading platform and the number of occupants increase. The off-road vehicle traveling on the uneven ground may be repeatedly and continuously in a power transmission state under high load because the off-road vehicle moves over an obstacle or travels up a hill. As compared to a vehicle traveling on a paved road, the off-road vehicle tends to be in a high-load traveling state, and the temperature of the belt tends to increase.

Since the inner diameter dimension Rr of the rotary portion facing surface 85a from the axis X1 increases toward the exhaust port 80c in the rotation direction of the drive pulley 50, the air having moved outward in the radial direction can be guided to the exhaust port 80c by rotation of the rotary portion 59, and the air discharging performance can be enhanced.

Since the rotary portion 59 has the recessed-projecting portion 59a, the recessed-projecting portion 59a can enhance the rotational force applied to the air positioned in the vicinity of the rotary portion 59 in the cup portion 85, and the air discharging performance can be enhanced.

Since the rotary portion 59 is positioned on the opposite side of the movable sheave 53 from the fixed sheave 52, the dimension of the rotary portion 59 can be increased in the direction opposite to the fixed sheave 52 in the direction along the axis X1. This can increase the rotational force applied to the air around the rotary portion 59, and can enhance the air discharging performance.

Since the intake port 80b is positioned on the opposite side of the fixed sheave 52 from the movable sheave 53, the air can be easily sucked through the intake port 80b by rotation of the fixed sheave 52, and ventilation performance can be improved. Since the intake port 80b is positioned on the opposite side of the fixed sheave 52 from the movable sheave 53, the intake port 80b is apart from the exhaust port 80c in the direction along the axis X1. This can prevent the air sucked through the intake port 80b from flowing directly toward the exhaust port 80c, and can promote temperature exchange between the belt 43 and the air.

Since the exhaust port 80c is positioned on the opposite side of the axis X1 from the far position 81c1 of the fixed sheave facing surface 81c as viewed in the direction along the axis X1, the direct flow of the air sucked through the intake port 80b to the exhaust port 80c can be prevented, and the temperature exchange between the belt 43 and the air can be promoted. Specifically, the air sucked through the intake port 80b is guided to the far position 81c1 of the surface facing the fixed sheave 52 by rotation of the fixed sheave 52. Since the exhaust port 80c is positioned on the opposite side of the axis X1 from the far position 81c1 of the fixed sheave facing surface 81c when viewed in the direction along the axis X1, the direct flow of the air sucked through the intake port 80b to the exhaust port 80c can be prevented.

Since the one pulley is the drive pulley 50, at the time of high-torque transmission in which the temperature of the belt 43 tends to increase, i.e., when the movable sheave 53 is apart from the fixed sheave 52, the area of the rotary portion 59 positioned in the cup portion 85 can be increased, and the air discharging performance can be enhanced.

Since the exhaust port 80c is opened upward, in a case where the CVT exhaust duct 32 is connected to the exhaust port 80c, the CVT exhaust duct 32 can easily extend upward, the upstream side of the CVT exhaust duct 32 in the air flow direction can easily extend upward, and the downstream side of the CVT exhaust duct 32 in the air flow direction can easily extend downward. With this configuration, when the vehicle travels in a marshy area or a boggy area, even if a foreign substance contained in the marshy area or the boggy area is caught and scattered by the wheels and enters the outlet 320 of the CVT exhaust duct 32, the foreign substance is less likely to flow backward in the CVT exhaust duct 32 from the outlet 320 of the CVT exhaust duct 32 toward the exhaust port 80c.

Since the CVT exhaust duct 32 includes the portion positioned higher than the outlet 320, when the vehicle travels in a marshy area or a boggy area, even if a foreign substance contained in the marshy area or the boggy area is caught and scattered by the wheels and enters the outlet 320 of the CVT exhaust duct 32, the foreign substance is less likely to flow backward in the CVT exhaust duct 32 from the outlet 320 of the CVT exhaust duct 32 toward the exhaust port 80c.

Since the rear end 80c1 of the exhaust port 80c is positioned in rear of the axis X1, in a case where the CVT exhaust duct 32 is connected to the exhaust port 80c, the amount of forward protrusion of the CVT exhaust duct 32 from the case 80 is reduced.

The case 80 is positioned below the loading platform 2, the exhaust port 80c is positioned in the front portion of the case 80, the CVT exhaust duct 32 is located in the space in front of the loading platform 2, and the upper end 32a of the CVT exhaust duct 32 is positioned in front of the bottom surface 2b of the loading platform 2. With this configuration, the routing path of the CVT exhaust duct 32 can be shortened.

Since the outlet 320 of the CVT exhaust duct 32 is positioned below the bottom surface 2b of the loading platform 2, the outlet 320 of the CVT exhaust duct 32 can be protected by the loading platform 2, and entrance of a foreign substance above the loading platform 2 into the outlet 320 of the CVT exhaust duct 32 can be prevented. For example, entrance of rainwater into the outlet 320 of the CVT exhaust duct 32 can be prevented.

Since the outlet 320 of the CVT exhaust duct 32 is opened to the engine 11, an increase in the temperature of the engine 11 due to exhaust air from the CVT exhaust duct 32 can be prevented.

Since the inlet 321 of the CVT exhaust duct 32 is positioned outside the outlet 320 of the CVT exhaust duct 32 in the vehicle width direction, a process of connecting or disconnecting the CVT exhaust duct 32 and the case 80 can be facilitated as compared to a case where the inlet 321 of the CVT exhaust duct 32 is positioned on the far side of the case 80. For example, in a case where the cover 82 is detached to replace the belt 43, the CVT exhaust duct 32 and the case 80 are easily disconnected from each other. The connection portion between the CVT exhaust duct 32 and the case 80 is preferably at such a position that the connection portion is exposed at the side of the vehicle body. This can make it easier to access the position of connection between the CVT exhaust duct 32 and the case 80 and to perform maintenance such as belt replacement.

Since the CVT exhaust duct 32 is folded back such that the upstream side and downstream side thereof are aligned in the vehicle width direction, part of the case 80 can be easily located in the area between the seats 6 and the loading platform 2.

Since the CVT intake duct 22 is fixed to the case body 81, workability can be enhanced without the need for disconnecting the CVT intake duct 22 from the case body 81 when the cover 82 is detached.

### Other Embodiments

The embodiment has been described above as an example of the technique disclosed in the present application. However, the technique in the present disclosure is not limited to above, and is also applicable to embodiments to which changes, replacements, additions, omissions, and the like are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

The power transmission structure is the continuously variable transmission 12, but may be a transmission other than the continuously variable transmission 12. The drive source is the engine 11, but may be an electric motor or a combination of an electric motor and an engine. The drive wheels are the rear wheels 4, but may be the front wheels 3 or the front wheels 3 and the rear wheels 4. The cooling target is the exhaust pipe of the engine 11, but other heat generating portions of the engine 11 may be cooled. Alternatively, the cooling target may be a heat generating component other than the engine, such as a voltage regulator. As another alternative, the cooling target may be a sensor located near a heat generating component to detect the state of exhaust gas, an actuator, or the like.

The case 80 does not necessarily have the cup portion 85 housing the drive pulley 50, but may have a bowl-shaped cup portion housing the driven pulley 70. That is, the driven pulley 70 is equivalent to the one pulley of the present disclosure. In this case, the cup portion covers at least part of a rotary portion of the driven pulley 70 rotating about the axis X2. The cup portion has a rotary portion facing surface facing the rotary portion in the radial direction thereof, and the exhaust port 80c is located in the rotary portion facing surface.

The rotary portion 59 includes the rotational motion mechanism 54, but is not limited thereto. For example, the rotary portion 59 preferably includes recesses and projections for rotating air. For example, the rotary portion 59 may newly include a blade for rotating air. The rotary portion may include part of the fixed sheave 52 of the drive pulley 50. The rotary portion may be a rotary portion rotating together with the driven pulley 70. In this case, the case 80 has a cup portion covering at least part of the driven pulley 70, the cup portion has a rotary portion facing surface facing the rotary portion in the radial direction of the driven pulley 70, and the exhaust port 80c is located in the rotary portion facing surface. In the present embodiment, the force of sucking air and the force of discharging air are generated by the same pulley, but may be generated by different pulleys.

The rotary portion 59 includes the rotational motion mechanism 54, but is not limited thereto. For example, the rotary portion may be one of the fixed sheave 72 or the movable sheave 73 of the driven pulley 70. In this case, the case 80 has a cup portion covering one of the sheaves of the driven pulley 70, the cup portion has a rotary portion facing surface facing the rotary portion in the radial direction of the one sheave, and the exhaust port 80c is located in the rotary portion facing surface.

The inner diameter dimension Rr of the rotary portion facing surface 85a increases toward the exhaust port 80c in the rotation direction of the drive pulley 50, but may be constant in the rotation direction of the drive pulley 50 or decrease toward the exhaust port 80c in the rotation direction of the drive pulley 50.

The rotary portion 59 has the recessed-projecting portion 59a, but does not necessarily have the recessed-projecting portion 59a.

The rotary portion 59 is positioned on the opposite side of the movable sheave 53 from the fixed sheave 52, but may be positioned on the opposite side of the fixed sheave 52 from the movable sheave 53.

The exhaust port 80c is positioned on the opposite side of the movable sheave 53 from the fixed sheave 52, but may be positioned on the opposite side of the fixed sheave 52 from the movable sheave 53. The number of exhaust ports 80c is not limited. As long as at least one exhaust port 80c is opened in the rotary portion facing surface 85a, the positions of the other exhaust ports 80c are arbitrary.

The intake port 80b is positioned on the opposite side of the fixed sheave 52 from the movable sheave 53, but may be positioned on the opposite side of the movable sheave 53 from the fixed sheave 52. The number of intake ports 80b is not limited. The position of the intake port 80b is arbitrary.

The exhaust port 80c is positioned on the opposite side of the axis X1 from the far position 81c1 of the fixed sheave facing surface 81c when viewed in the direction along the axis X1, but may be positioned on the same side as the far position 81c1 of the fixed sheave facing surface 81c with respect to the axis X1.

The exhaust port 80c is opened upward, but may be opened forward, rearward, or downward.

The CVT exhaust duct 32 includes the portion positioned higher than the outlet 320, but does not necessarily include such a portion.

The rear end 80c1 of the exhaust port 80c is positioned in rear of the axis X1, but may be positioned in front of the axis X1 or be at the same position as that of the axis X1.

The exhaust port 80c is positioned in the front portion of the case 80, but may be positioned in a rear portion of the case 80.

The CVT exhaust duct 32 is located in the space in front of the loading platform 2, but may be located on the right or left side of the loading platform 2.

The upper end 32a of the CVT exhaust duct 32 is positioned in front of the bottom surface 2b of the loading platform 2, but may be positioned in rear of the bottom surface 2b of the loading platform 2.

The outlet 320 of the CVT exhaust duct 32 is positioned below the bottom surface 2b of the loading platform 2, but may be positioned above the bottom surface 2b of the loading platform 2.

The outlet 320 of the CVT exhaust duct 32 is opened to the cooling target (engine 11), but is not necessarily opened to the cooling target.

The inner surface of the cup portion 85 is preferably in the scroll shape, but is not necessarily in the scroll shape.

The continuously variable transmission 12 generates, in the case 80, the force of sucking air by the fixed sheave 52 of the drive pulley 50, but does not necessarily generate the force of sucking air.

The CVT intake duct 22 may include CVT intake ducts 22, or the CVT exhaust duct 32 may include CVT exhaust ducts 32. In this case, each of the CVT exhaust ducts 32 may be connected to the cup portion 85, or at least one of the CVT exhaust ducts 32 may be connected to the cup portion 85.

The CVT intake duct 22 and the CVT exhaust duct 32 are not necessarily integrated. Specifically, the CVT intake duct 22 for guiding air into the case 80 and the CVT exhaust duct 32 for guiding air to the outside of the case 80 may be separated from each other.

Assuming traveling in the situation where the water surface is relatively high, the upper ends of the CVT intake duct 22 and the CVT exhaust duct 32 are set, but are not limited thereto. That is, assuming traveling in a dry area, the upper end of each duct 22, 32 may be located at a position lower than the seating surface of the seat 6.

The technique disclosed here may be applied to an off-road vehicle other than the utility vehicle 100.

### ASPECTS

The above-described embodiment is a specific example of the following aspects.

### First Aspect

The continuously variable transmission 12 (one example of a power transmission structure) includes the belt transmission mechanism 40 having the drive pulley 50, the driven pulley 70, and the belt 43 wound between the drive pulley 50 and the driven pulley 70, and the case 80 having the internal space 80a in which the belt transmission mechanism 40 is housed, the intake port 80b which communicates with the internal space 80a and through which air is sucked into the internal space 80a, and the exhaust port 80c which communicates with the internal space 80a and through which air is discharged from the internal space 80a. The case 80 has the bowl-shaped cup portion 85 housing the one pulley 50 of the drive pulley 50 or the driven pulley 70, and the cup portion 85 covers at least part of the rotary portion 59 of the one pulley 50 rotating about the axis X1 of the one pulley 50. The cup portion 85 has the rotary portion facing surface 85a facing the rotary portion 59 in the radial direction thereof, and the exhaust port 80c is opened in the rotary portion facing surface 85a.

According to this configuration, in a case where the one pulley 50 rotates about the axis X1, the air positioned in the vicinity of the rotary portion 59 in the cup portion 85 rotates about the axis X1 and the centrifugal force is applied thereto by rotation of the rotary portion 59. In this manner, the air positioned in the cup portion 85 is prompted to move toward the exhaust port 80c along the rotary portion facing surface 85a, and the air discharging performance can be enhanced. Consequently, the inside of the case 80 can be ventilated, and an increase in the temperature of the belt 43 can be suppressed.

### Second Aspect

In the continuously variable transmission 12 according to the first aspect, the inner diameter dimension Rr of the rotary portion facing surface 85a from the axis X1 increases toward the exhaust port 80c in the rotation direction of the one pulley 50. According to this configuration, the air having moved outward in the radial direction can be guided to the exhaust port 80c by rotation of the rotary portion 59, and the air discharging performance can be enhanced.

### Third Aspect

In the continuously variable transmission 12 according to the first or second aspect, the rotary portion 59 has the recessed-projecting portion 59a whose dimension in the radial direction varies in the rotation direction of the one pulley 50.

According to this configuration, the recessed-projecting portion 59a can enhance the rotational force applied to the air positioned in the vicinity of the rotary portion 59 in the cup portion 85, and the air discharging performance can be enhanced.

### Fourth Aspect

In the continuously variable transmission 12 according to any one of the first to third aspects, the one pulley 50 includes the movable sheave 53 movable in the direction along the axis X1, and the fixed sheave 53 whose movement in the direction along the axis X1 is blocked, and the rotary portion 59 is positioned on the opposite side of the movable sheave 53 from the fixed sheave 52.

According to this configuration, the dimension of the rotary portion 59 can be increased in the direction opposite to the fixed sheave 52 in the direction along the axis X1. This can increase the rotational force applied to the air around the rotary portion 59, and can enhance the air discharging performance.

### Fifth Aspect

In the continuously variable transmission 12 according to any one of the first to fourth aspects, the intake port 80b is positioned on the opposite side of the fixed sheave 52 from the movable sheave 53.

According to this configuration, air can be easily sucked through the intake port 80b by rotation of the fixed sheave 52, and the ventilation performance can be improved. The intake port 80b is apart from the exhaust port 80c in the direction along the axis X1. This can prevent the air sucked through the intake port 80b from flowing directly toward the exhaust port 80c, and can promote the temperature exchange between the belt 43 and the air.

### (Sixth Aspect

In the continuously variable transmission 12 according to any one of the first to fifth aspects, the case 80 has the fixed sheave facing surface 81c facing the fixed sheave 52 in the radial direction thereof, the inner diameter dimension Rs of the fixed sheave facing surface 81c from the axis X1 increases with an increase in the distance from the intake port 80b in the rotation direction of the one pulley 50, and when viewed in the direction along the axis X1, the exhaust port 80c is positioned on the opposite side of the axis X1 from the far position 81c1 at which the inner diameter dimension Rs of the fixed sheave facing surface 81c from the axis X1 is maximum.

According to this configuration, the direct flow of the air sucked through the intake port 80b to the exhaust port 80c can be prevented, and the temperature exchange between the belt 43 and the air can be promoted.

### Seventh Aspect

In the continuously variable transmission 12 according to any one of the first to sixth aspects, the one pulley 50 is the drive pulley 50.

According to this configuration, at the time of high-torque transmission in which the temperature of the belt 43 tends to increase, i.e., when the movable sheave 53 is apart from the fixed sheave 52, the area of the rotary portion 59 positioned in the cup portion 85 can be increased, and the air discharging performance can be enhanced.

### Eighth Aspect

In the continuously variable transmission 12 according to any one of the first to seventh aspects, the exhaust port 80c is opened upward.

According to this configuration, in a case where the exhaust duct 32 is connected to the exhaust port 80c, the exhaust duct 32 can easily extend upward, the upstream side of the exhaust duct 32 in the air flow direction can easily extend upward, and the downstream side of the exhaust duct 32 in the air flow direction can easily extend downward. With this configuration, when the vehicle travels in a marshy area or a boggy area, even if a foreign substance contained in the marshy area or the boggy area is caught and scattered by the wheels and enters the outlet 320 of the exhaust duct 32, the foreign substance is less likely to flow backward in the exhaust duct 32 from the outlet 320 of the exhaust duct 32 toward the exhaust port 80c.

### Ninth Aspect

In the continuously variable transmission 12 according to any one of the first to eighth aspects, the exhaust duct 32 is connected to the exhaust port 80c, and the exhaust duct 32 includes the portion positioned higher than the outlet 320 of the exhaust duct 32 on the upstream side of the outlet 320 in the air flow direction.

According to this configuration, when the vehicle travels in a marshy area or a boggy area, even if a foreign substance contained in the marshy area or the boggy area is caught and scattered by the wheels and enters the outlet 320 of the exhaust duct 32, the foreign substance is less likely to flow backward in the exhaust duct 32 from the outlet 320 of the exhaust duct 32 toward the exhaust port 80c

### Tenth Aspect

In the continuously variable transmission 12 according to any one of the first to ninth aspects, the rear end 80c1 of the exhaust port 80c is positioned in rear of the axis X1.

According to this configuration, in a case where the exhaust duct 32 is connected to the exhaust port 80c, the amount of forward protrusion of the exhaust duct 32 from the case 80 is reduced.

### Eleventh Aspect

The utility vehicle 100 (one example of an off-road vehicle) includes the engine 11 (one example of a drive source), the rear wheels 4 (one example of a drive wheel), and the power transmission structure that transmits the torque of the engine 11 to the rear wheels 4. The power transmission structure has the belt transmission mechanism 40 having the drive pulley 50, the driven pulley 70, and the belt 43 wound between the drive pulley 50 and the driven pulley 70, and the case 80 having the internal space 80a in which the belt transmission mechanism 40 is housed, the intake port 80b which communicates with the internal space 80a and through which air is sucked into the internal space 80a, and the exhaust port 80c which communicates with the internal space 80a and through which air is discharged from the internal space 80a. The case 80 has the bowl-shaped cup portion 85 housing the one pulley 50 of the drive pulley 50 or the driven pulley 70, and the cup portion 85 covers at least part of the rotary portion 59 of the one pulley 50 rotating about the axis X1 of the one pulley 50. The cup portion 85 has the rotary portion facing surface 85a facing the rotary portion 59 in the radial direction thereof, and the exhaust port 80c is opened in the rotary portion facing surface 85a.

According to this configuration, in a case where the one pulley 50 rotates about the axis X1, the air positioned in the vicinity of the rotary portion 59 in the cup portion 85 rotates about the axis X1 and the centrifugal force is applied thereto by rotation of the rotary portion 59. In this manner, the air positioned in the cup portion 85 is prompted to move toward the exhaust port 80c along the rotary portion facing surface 85a, and the air discharging performance can be enhanced. Consequently, the inside of the case 80 can be ventilated, and an increase in the temperature of the belt 43 can be suppressed.

### Twelfth Aspect

The utility vehicle 100 according to the eleventh aspect further includes the loading platform 2 located above the rear wheels 4 which are the drive wheels, and the exhaust duct 32 connected to the exhaust port 80c. The case 80 is positioned below the loading platform 2, and the exhaust port 80c is positioned in the front portion of the case 80. The exhaust duct 32 is located in the space in front of the loading platform 2, and the upper end 32a of the exhaust duct 32 is positioned in front of the bottom surface 2b of the loading platform 2.

According to this configuration, the routing path of the exhaust duct 32 can be shortened.

### Thirteenth Aspect

In the utility vehicle 100 according to the eleventh or twelfth aspect, while extending to the downstream side in the air flow direction, the exhaust duct 32 extends upward of the bottom surface 2b of the loading platform 2, is folded back, and extends downward, and the outlet 320 of the exhaust duct 32 is positioned below the bottom surface 2b of the loading platform 2.

According to this configuration, the outlet 320 of the exhaust duct 32 can be protected by the loading platform 2, and entrance of a foreign substance above the loading platform 2 into the outlet 320 of the exhaust duct 32 can be prevented.

### Fourteenth Aspect

In the utility vehicle 100 according to any one of the eleventh to thirteenth aspects, the outlet 320 of the exhaust duct 32 is opened to the engine 11 (one example of a cooling target).

According to this configuration, an increase in the temperature of the engine 11 due to exhaust air from the exhaust duct 32 can be prevented.

What is claimed:

1. A power transmission structure comprising:
a belt transmission mechanism including a drive pulley, a driven pulley, and a belt wound between the drive pulley and the driven pulley; and
a case including an internal space in which the belt transmission mechanism is housed, an intake port which communicates with the internal space and through which air is sucked into the internal space, and an exhaust port which communicates with the internal space and through which air is discharged from the internal space,
wherein the case has a bowl-shaped cup portion housing one pulley of the drive pulley or the driven pulley, and the cup portion covers at least part of a rotary portion of the one pulley rotating about an axis of the one pulley, and
the cup portion has a rotary portion facing surface facing the rotary portion in a radial direction thereof, and the exhaust port is opened in the rotary portion facing surface.

2. The power transmission structure according to claim 1, wherein
an inner diameter dimension of the rotary portion facing surface from the axis increases toward the exhaust port in a rotation direction of the one pulley.

3. The power transmission structure according to claim 1, wherein
the rotary portion has a recessed-projecting portion whose dimension in the radial direction varies in the rotation direction of the one pulley.

4. The power transmission structure according to claim 1, wherein
the one pulley includes a movable sheave movable in a direction along the axis, and a fixed sheave whose movement in the direction along the axis is blocked, and
the rotary portion is positioned on an opposite side of the movable sheave from the fixed sheave.

5. The power transmission structure according to claim 4, wherein
the intake port is positioned on an opposite side of the fixed sheave from the movable sheave.

6. The power transmission structure according to claim 5, wherein
the case has a fixed sheave facing surface facing the fixed sheave in a radial direction thereof,
an inner diameter dimension of the fixed sheave facing surface from the axis increases with an increase in a distance from the intake port in the rotation direction of the one pulley, and
when viewed in the direction along the axis, the exhaust port is positioned on an opposite side of the axis from a far position at which the inner diameter dimension of the fixed sheave facing surface from the axis is maximum.

7. The power transmission structure according to claim 4, wherein the one pulley is the drive pulley.

8. The power transmission structure according to claim 1, wherein the exhaust port is opened upward.

9. The power transmission structure according to claim 1, wherein
an exhaust duct is connected to the exhaust port, and
the exhaust duct includes a portion positioned higher than an outlet of the exhaust duct on an upstream side of the outlet in an air flow direction.

10. The power transmission structure according to claim 1, wherein a rear end of the exhaust port is positioned in rear of the axis.

11. An off-road vehicle comprising:
a drive source;
a drive wheel; and
a power transmission structure that transmits torque of the drive source to the drive wheel,
wherein the power transmission structure includes
a belt transmission mechanism having a drive pulley, a driven pulley, and a belt wound between the drive pulley and the driven pulley, and
a case having an internal space in which the belt transmission mechanism is housed, an intake port which communicates with the internal space and through which air is sucked into the internal space, and an exhaust port which communicates with the internal space and through which air is discharged from the internal space,
the case has a bowl-shaped cup portion housing one pulley of the drive pulley or the driven pulley, and the cup portion covers at least part of a rotary portion of the one pulley rotating about an axis of the one pulley, and
the cup portion has a rotary portion facing surface facing the rotary portion in a radial direction thereof, and the exhaust port is opened in the rotary portion facing surface.

12. The off-road vehicle according to claim 11, further comprising:
a loading platform located above a rear wheel which is the drive wheel; and
an exhaust duct connected to the exhaust port,
wherein the case is positioned below the loading platform, and the exhaust port is positioned in a front portion of the case, and
the exhaust duct is located in a space in front of the loading platform, and an upper end of the exhaust duct is positioned in front of a bottom surface of the loading platform.

13. The off-road vehicle according to claim 12, wherein
while extending to a downstream side in an air flow direction, the exhaust duct extends upward of the bottom surface of the loading platform, is folded back, and extends downward, and an outlet of the exhaust duct is positioned below the bottom surface of the loading platform.

14. The off-road vehicle according to claim 13, wherein
the outlet of the exhaust duct is opened to a cooling target.
